(19) United States
(12) Patent Application Publication
(10) Pub. No.: US 2016/0293352 A1
(43) Pub. Date: Oct. 6, 2016

(54) METHOD FOR PRODUCING PLATE ARRANGEMENTS AND USE THEREOF

(71) Applicant: EATON ELECTRICAL IP GMBH & CO. KG, Schoenefeld (DE)

(72) Inventors: Albert Zacharias, Neuwied (DE); Christian Ruempler, Wexford (Marshall Township), PA (US)

(21) Appl. No.: 15/034,184

(22) PCT Filed: Oct. 21, 2014
(86) PCT No.: PCT/EP2014/072530

§ 371 Date: May 4, 2016

(30) Foreign Application Priority Data
Nov. 7, 2013 (DE) 102013112238.8

(51) Int. Cl. H01H 9/34; B21D 53/04; F28F 3/08; B21D 39/03; F28D 1/03; F28D 9/00; H01H 9/36; B21D 28/10

(52) U.S. Cl. CPC H01H 9/342; H01H 9/36; B21D 53/04; B21D 28/10; B21D 39/035; F28D 1/0366; F28D 9/0062; F28F 3/08; F28F 2275/04; F28F 2275/12; F28F 2275/143

(57) ABSTRACT

A method for producing plate arrangements and using these for cooling gaseous blow-off in electric installation devices, produces a plate stack, which is formed in a cuboidal shape, with a stack length and a stack width. The plate stack is made of shaped rectangular sheets which are produced using a shaping process and are sheet-metal strips of a uniform thickness. First shaped sheets with a uniform length which corresponds to the stack length and second shaped sheets with a width which corresponds maximally to the stack width are used. The shaped sheets are stacked one on top of the other after being shaped such that multiple continuous cavities, i.e., slots, are formed in the longitudinal direction of the stack parallel to the uniform length, and the shaped sheets are connected to one another in a captive mariner so as to form a self-supporting structure of a plate stack.

### CROSS-REFERENCE TO RELATED APPLICATIONS

This application is a U.S. national stage application under 35 U.S.C. §371 of International Application No. PCT/EP2014/072530, filed on Oct. 21, 2014, and claims benefit to German Patent Application No. DE 10 2013 112 238.8, filed on Nov. 7, 2013. The International Application was published in German on May 14, 2015, as WO 2015/067462 A1 under PCT Article 21(2).

### FIELD

The invention relates to a method for producing plate arrangements and to a use of the plate arrangements for cooling gaseous blow-off in electrical installation devices.

### BACKGROUND

Devices for cooling breaking gas in low-voltage circuit breakers are known in which a close-meshed metal grid or grating is used (EP 0817223 B1).

Blow-off cooling is also described elsewhere, for example: U.S. Pat. No. 7,488,915 B2 or DE 102010034264 B3.

In these documents, the flow paths are diverted on multiple occasions. These arrangements are disadvantageous in that pressure builds up along the cooling device as a result of the flow being diverted, and this adversely affects the switching performance. To avoid this repercussion, the cross section has to be enlarged.

If flow is guided in a complex manner (if, inter alia, there are several diversions) and if the structure is intricate and comprises a close cooling meshing (EP 0817223 A1), this may result in the flow channels becoming blocked by particles in the blow-off and may result in damage to the meshing.

DE 1640265 A1 discloses a cascade of cooling devices in which plates are bent at the outlet of a precooler, the intention of which is to block the return path of electric arcs. DE 35 41 514 A1 also discloses an electric arc quenching chamber comprising an attachment for cooling the effluent gases further.

### SUMMARY

An aspect of the invention provides a method for producing a cuboid plate stack having a stack length and a stack width, the plate stack including shaped metal sheets that are rectangular or L-shaped and each produced from a metal strip of a uniform thickness by shaping and include first shaped metal sheets having a uniform length that corresponds to the stack length and second shaped metal sheets having a uniform width that is at most equal to the stack width, each first shaped metal sheet including a first portion including a first planar sub-surface and a second portion including a second planar sub-surface, each second shaped metal sheet including a first portion including a first planar sub-surface, the method comprising: stacking the first and second shaped metal sheets one on top of the other, after the shaping of the shaped metal sheets, such that a plurality of through-cavities, in the form of vents, are formed in a longitudinal direction of the stack in parallel with the uniform length between respective planar sub-surfaces of the second portions of the first shaped metal sheets, a respective first portion of the second shaped metal sheets acting as a spacer for forming the vents, and the respective planar sub-surface of the first portion of the second shaped metal sheets resting on the respective planar sub-surface of the first portion of the first shaped metal sheets; and interconnecting the shaped metal sheets in a captive manner so as to form a self-supporting structure of a plate stack, wherein, in order to produce the self-supporting structure, each of the planar sub-surfaces of at least the first portion of the first and second shaped metal sheets is provided with debossed bulges such that, when the planar sub-surfaces of first portions of the first and second shaped metal sheets that rest one on top of the other are stacked, bulges and debossed impressions engage with one another.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a basic design of a plate stack;

FIG. 2 shows a schematic design of a punch-bundled plate arrangement;

FIG. 3 is a schematic diagram of a punch-bundling process;

FIG. 4 shows a plate arrangement having central support;

FIG. 5 shows support by means of staggered plates;

FIG. 6 is a sectional view of a plate arrangement comprising a vent that is variable in the flow direction;

FIG. 7 shows a plate arrangement having a variable number of vents;

FIG. 8 is a sectional view of a plate arrangement having a varying number of vents and a varying vent width; and

FIG. 9 shows a cooling device having an integrated plate stack.

### DETAILED DESCRIPTION

An aspect of the invention provides a method for producing plate stacks that is suitable for being carried out in series production. An aspect also provides the use of plate stacks of this type in cooling devices for cooling gaseous blow-off in electrical installation devices.

An embodiment provides a method for producing a cuboid plate stack that has a stack length, a stack width and a stack height and is formed by various shaped metal sheets, the plate stack being made of rectangular shaped metal sheets that are each produced from a metal strip of uniform thickness by means of shaping. For the shaping processing, stamping, wire eroding, laser cutting, water jet cutting or nibbling is used. However, what is particularly used is the punch-bundling method.

The shaped metal sheets (plates) in the plate stack should have a uniform length in the direction of the stack length and may have various widths that are less than the stack width of the cuboid.

In this respect, first shaped metal sheets having a uniform length that corresponds to the stack length and second shaped metal sheets having a width that is at most equal to the stack width are produced, at least one shaped metal sheet acting as a plate of a large width and at least one second shaped metal sheet acting as a plate of a narrow width in the plate stack.

According to an aspect of the invention, a plate stack is produced by stacking plates one on top of the other, which plates consisting of various shaped metal sheets and being of different thicknesses. In this case, the shaped metal sheets (outline) are selected such that cooling plates are produced so as to alternate with the shaped metal sheets and such that other shaped metal sheets acting as spacer sheets form cooling vents therebetween. In the simplest case, only first shaped metal sheets having a uniform length and second shaped metal sheets having different widths are intended be used. The various shaped metal sheets are formed by being stacked so as to form a plate stack. In general, the first shaped metal sheets form the cooling plates (or cooling sheets) and the second shaped metal sheets form the spacer sheets. The height of the vents through which a flow passes is formed by the spacer sheets.

The expressions “plate” and “shaped metal sheet” are intended to be used synonymously hereinafter.

The shaped metal sheets are stacked one on top of the other after the shaping thereof such that a plurality of through-cavities, referred to hereinafter as vents, are formed in the longitudinal direction of the stack so as to be parallel to the uniform length and are also interconnected in a captive manner in the plate stack so as to form a compact body. The plate stack has a self-supporting structure.

The use of the plate stack is also provided whereby the plate stack is used in cooling devices for cooling blow-off gases of electrical switching devices, in particular low-voltage switching devices.

Introducing substantially planar, parallel plates in the plate stack which are arranged with narrow spacing in the range between 0.1 and 0.5 mm is proposed. Maintaining this spacing is crucial for the cooling device to work efficiently. Therefore, with regard to arranging and securing the plates, the design should take into account the possibility of narrow tolerances and suitability for series production. Furthermore, the plates are arranged in the plate stack such that sufficient sealing against leakage flows is produced, and therefore it is not possible for breaking gases to leave the switching device without having been cooled.

In the present plate arrangement, the plates are relatively thin and the spacing thereof is small and sensitive in terms of tolerances. Furthermore, the metal plates can generally be interconnected in an electrically conductive manner, meaning that they are unsuitable for electric arc quenching devices.

The punch-bundling method is preferably intended to be used. In this process, the various plates are stamped in a processing step, stacked so as to form a single plate arrangement and then interconnected.

To connect the plates, bulges (stacking bulges) can be embossed into the plates. Bulges are stamped impressions that have not been stamped the whole way through. Therefore, the part of the bulge projecting from the upper plate can engage in the recess of the plate located therebelow and thus interconnect the plates. When the desired stack height (stack thickness formed by a number of plates) is achieved, a cover plate is stamped, in which process through-holes (drill holes) are produced instead of bulges. There is no connection to the plate located therebelow. By using cover plates having drill holes, it is possible to produce individual plate stacks in direct succession in the punch-bundling process, and therefore the plate stacks are separated from one another. A punch-bundling method results in the plate arrangement leaving the stamping tool ready assembled and connected.

In order for it to be possible for both the plates having connection bulges and cover plates having holes to be punched in one stamping tool, individual stamping stations in the punch-bundling tools have to be activated and then deactivated between the stamping strokes. If there are a plurality of stations of this type, it is also possible to produce plate stacks in which geometrically different plates can be interconnected in a single tool to form a stack.

In principle, a plate stack is produced by stacking various shaped metal sheets, it also being possible for a plurality of similar shaped metal plates to be located one on top of the other in order to produce, from a desired plate thickness, plate thicknesses and vent widths that differ therefrom, for example.

After the plates and sheets have been produced, they can also be assembled to form plate arrangements both manually (for small quantities) or semi-automatically (for large quantities and large-scale production). In large-scale production, the shaped metal sheets can also be assembled in a fully automated manner at the same time as they are produced.

The following features may in embodiments be implemented either individually or in combination with one another (as far as is feasible).

In another embodiment, two first shaped metal sheets are stacked one on top of the other, followed by a second shaped metal sheet.

By modifying the processing of the metal strip, plates of the first shaped metal sheet can be produced so as to have beading.

By processing the metal strip in yet another way, plates of the first shaped metal sheet can be produced so as to be L-shaped.

The number of vents extending in the longitudinal direction in parallel with the stack length can also be variable.

By stacking in principle any number of individual shaped metal sheets one on top of the other, various plate thicknesses and vent widths can be produced from one metal strip of uniform thickness. However, two plates acting as cooling plates are preferably intended to be stacked, followed by one spacer plate (referred to as the “2:1 sequence”). In this case, the thickness of the metal strip is preferably selected so as to be in the range of between 0.1 to 0.5 mm.

To achieve the compact structure, the shaped metal sheets of the plate stack can be welded or soldered at the edges. For interconnecting the shaped metal sheets consisting of plates and sheets to form a compact and stable plate stack, a choice of methods having various degrees of automation are available. By way of example, such methods for producing frictional and/or interlocking connections are described here; the list is however not exhaustive: using clips or clamps, soldering or welding (e.g. laser soldering all the plates), even carrying out these processes directly in the stamping and stacking tool, for example.

Rivet-fastening the plates in the plate stack has already been mentioned above.

Other possibilities include:

Inserting Spacer Plates in Central Positions

In wider cooling vents, in order to reduce the risk of the vent width not being maintained as a result of plates bending, central spacer sheets (1 or more) are also intended to be used in addition to lateral spacer sheets.

Using Staggered Plates

Alternatively, however, wide flow vents can be kept stable by overlapping the sheets and plates. By arranging the plates so as to be staggered, staggered cooling vents can also be produced, which also results in the plate stack being kept stable.

Using Lateral Spacer Sheets

In order to laterally seal the flow vents, shaped metal sheets for cooling plates are proposed that are produced so as to have beading. The spacer sheets and the lateral shaped metal sheets acting as spacers (see for example FIG. 8) can laterally seal the flow vent at the same time.

Varying the Vent Width using Plates Embossed in a Planar Manner

Owing to additional planar embossing (also owing to the formation of beading) of individual plates, the vent width can, where necessary, vary over the flow length.

Varying the Number of Vents

Changing the number of vents in the flow direction in a plate stack is also proposed, and this optimizes the cooling effect on the changing temperatures of the gases when said gas flows through the vents. By combining the above-mentioned variants, a wide vent can also open into a plurality of narrow vents.

The produced plate stacks are therefore suitable for being introduced and used in low-voltage installation devices. They can therefore be used as part of a breaking gas cooling device. In order to function, such a cooling device may require a holding device (frame/housing) which receives the plate stack, in addition to sufficient sealing against lateral flows passing the plate stack that is provided by sealing means. In theory, a cooling device having the different proposed design variants of a plate stack can be used in all electromechanical switching devices that generate significant levels of blow-off. This is particularly advantageous in low-voltage circuit breakers, low-voltage miniature circuit breakers and low-voltage motor-protection circuit breakers.

The material of the plates is intended to have the highest possible heat conductivity, and therefore the plates can be made of steel, copper or a highly conductive ceramic material.

Advantages of the invention include:

The production method is suitable for series production;

A narrow defined distance between the plates is maintained;

Handling during use is simplified owing to the plate arrangement being pre-assembled.

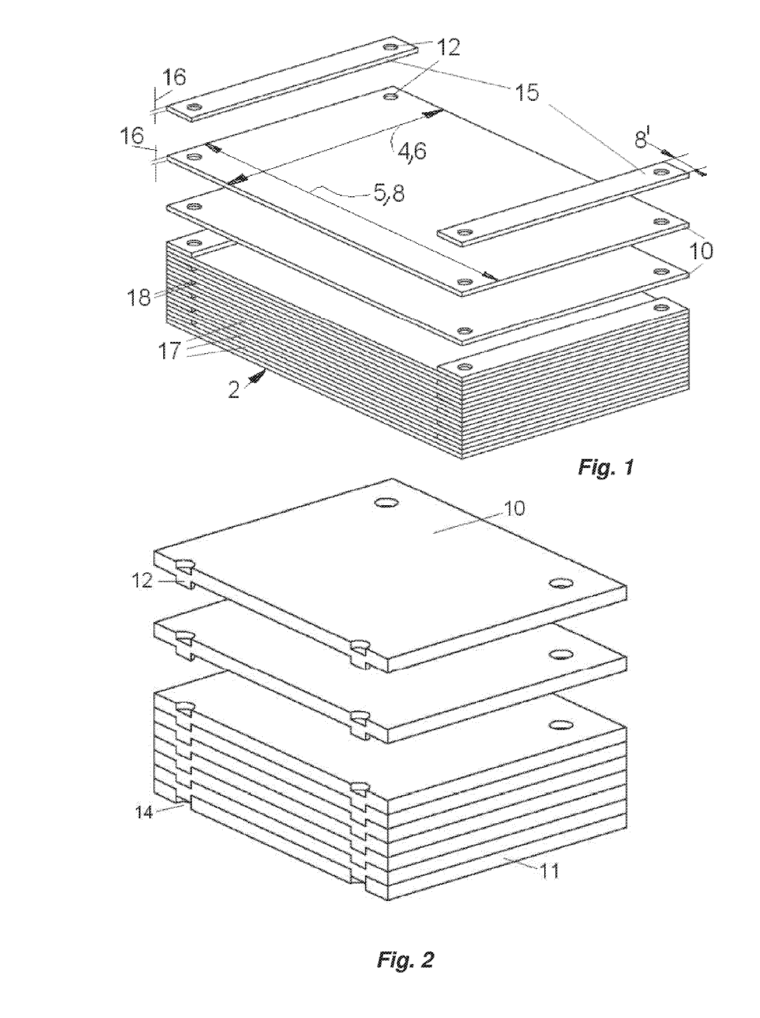

FIG. 1 shows a basic design of a plate stack. The shape of the plate stack 2 is a cuboid having a stack length 4, a stack width 5 and a stack height. The design of the plate stack comprises the following components: planar plates (2×10) consisting of, for example, two individual plates located one on top of the other, lateral spacer sheets 15, connection bulges 12, flow vents 17, flow vent width 18 and plate thickness 16.

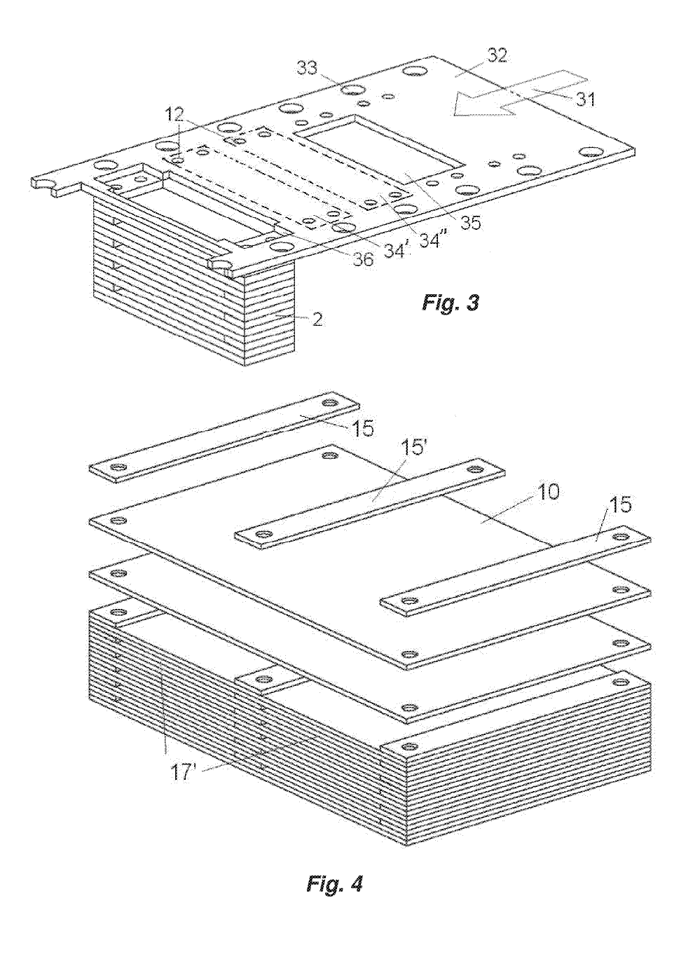

In this figure, in the simplest case, two different shaped metal sheets are stamped that ultimately form cooling plates (or cooling sheets) and the spacer sheets that form the vent through which a flow passes (FIG. 1—having rectangular cooling plates; FIG. 3—having spacer sheets). By stacking in principle any number of individual shaped metal sheets one on top of another, various plate thicknesses and vent widths can be produced from one metal strip of a uniform thickness. However, it is preferable for two plates acting as cooling plates to be stacked, followed by a single spacer plate. In this case, the thickness of the metal strip is preferably selected so as to be in the range of between 0.1 mm to 0.5 mm.

FIG. 2 shows a schematic design of a punch-bundled plate stack. The design of the plate stack comprises: “regular” planar plates 10 having connection bulges 12, a cover or closure sheet 11, and a through-hole 14 in the closure sheet 11. FIG. 2 does not show spacer sheets, which are necessary for forming flow vents.

FIG. 3 is a schematic diagram showing the punch-bundling process for producing a plate stack 2 having two cooling plates one on top of the other and a single spacer element (in a sequence referred to as the “2:1 sequence”). The reference numerals used in the figure are as follows: feed direction 31, metal strips 32, driving holes 33 for feeding and positioning, connection bulges 12, stamping a recess 35, final stamping 36 of the outer shape (cooling plate or vent), completed plate stack 2. The stamping station in which the stamped, shaped metal sheets are directly combined to form a stack is shown at the front of the drawing. Other stations in which outlines are pre-stamped may be situated upstream of the stamping station. Reference numeral 35 thus denotes a recess which has been pre-stamped and in which only the lateral spacer elements are stamped in the upstream stamping station. The two reference numerals 34′ and 34″ denote outlines that are intended to be stamped out in the stamping stations so as to produce cooling plates. By way of example, FIG. 3 shows round connection bulges 12, but the actual choice of the shape of the bulges is not intended to be limiting.

FIG. 4 shows a plate arrangement having central support. In this figure, central spacer sheets are also used. So as to avoid the problem that occurs in wider cooling vents whereby the cooling plates 10 bend, meaning that the vent width is not kept the same, central spacer sheets 15′ (1 or more) are also used in addition to lateral spacer sheets. Owing to the additional, central spacer sheets, a multipart flow vent 17′ is present in the plate stack.

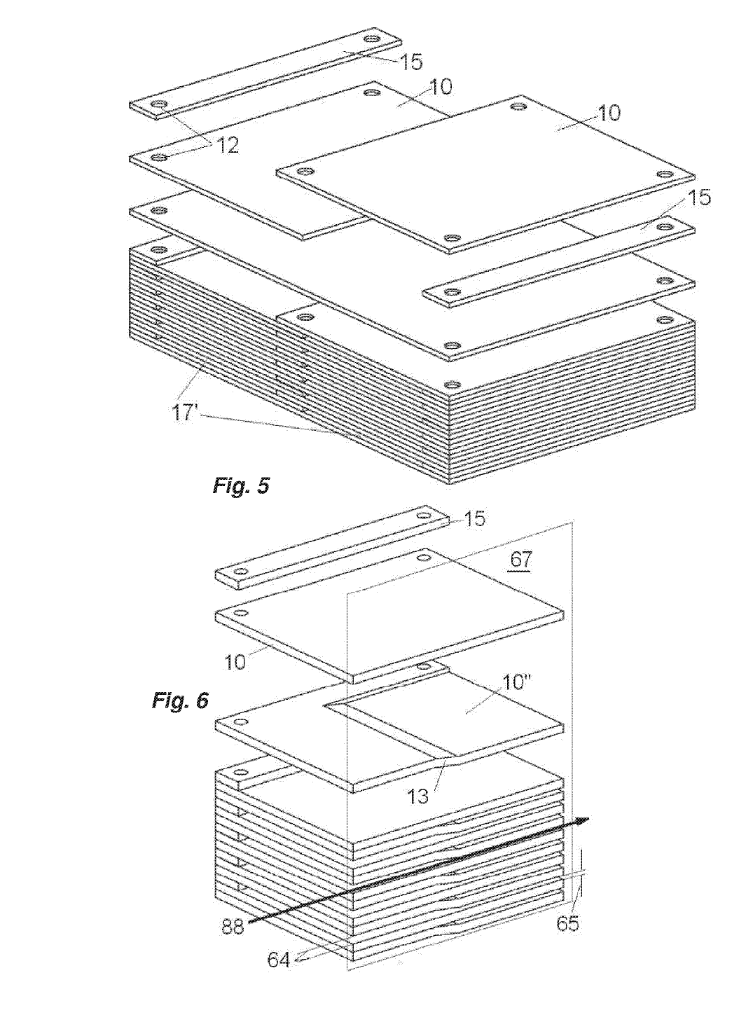

FIG. 5 shows the support that is substantially in the central position formed by using cooling plates that are arranged so as to be staggered, thus forming staggered cooling vents 17″.

FIG. 6 is a sectional view of an example shape of a plate arrangement in which a variable vent width in the flow direction 88 and in the flow length is provided. Owing to additional, planar embossing of individual plates (production of beading 13), it is possible, where necessary, to vary the vent width over the flow length. Owing to the planar embossing, a second portion of the plate is moved in parallel by approximately half the thickness with respect to a first portion of the plate. The reference numerals in the figure are as follows: spacer sheet 15″, flow 88 that flows through a vent and separates into two vents in the stack, regular cooling plate 10, cooling plate 10″ having beading 13, wide vent 64 in the input region, narrow vent 65 in the outlet region, flow direction 88 and sectional plane 67.

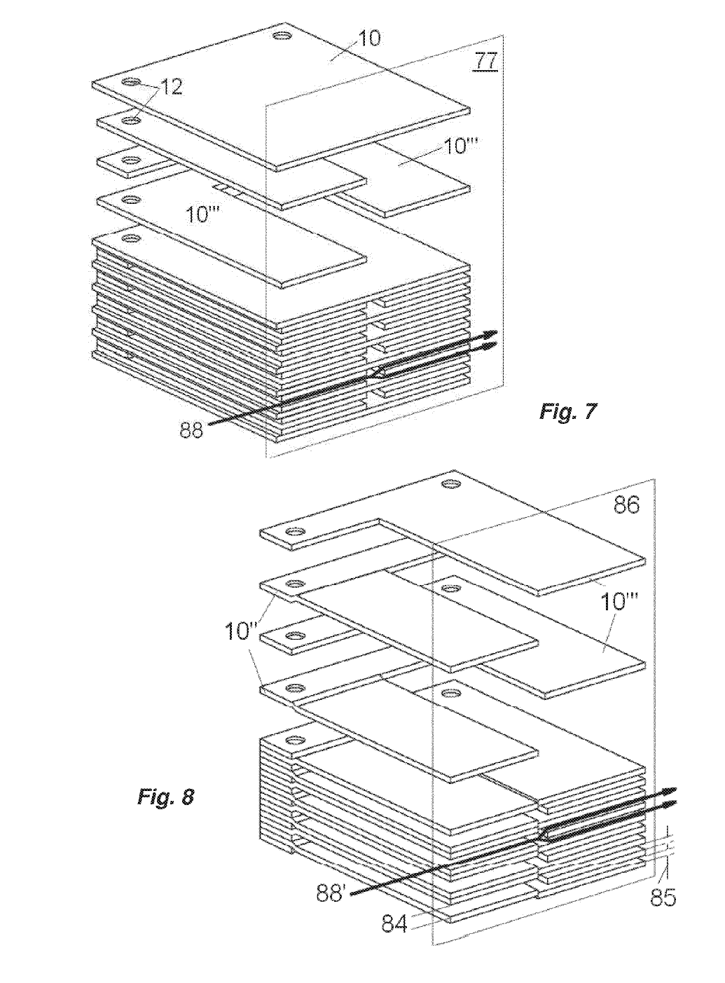

FIG. 7 is a sectional view (sectional plane 77) of a plate arrangement having a variable number of vents. In this case, the number of vents in the flow direction 88 in a plate stack is changed. By virtue of the implemented variant using angularly cut cooling plates 10″′ (plates that are not rectangular but rather substantially L-shaped), the cooling device can be optimized to changing gas temperatures when the gas flows through.

FIG. 8 is a sectional view (sectional plane 86) of a combination of the approaches from FIG. 6 and FIG. 7. In this figure, the flow 88 through a wide vent 84 is intended to flow into a plurality of narrow vents 85. A plate arrangement is shown in which the cooling effect is increased by means of a variable number of vents and a vent width that is variable in the flow direction. FIG. 8 shows cooling plates 10″ having beading 13, planar cooling plates 10″′ cut at an angle, a wide vent 84 in the input region, two narrow vents 85 in the output region, and a flow 88′ that is separated into two vents.

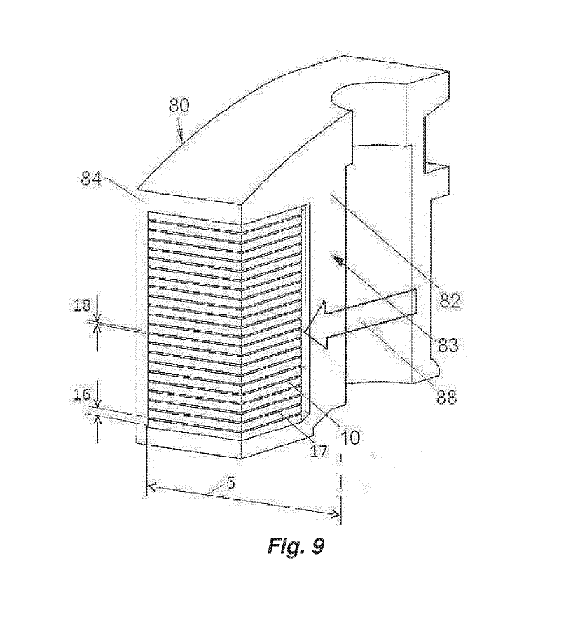

Finally, FIG. 9 is a sectional view of a cooling device 80 that is held in a frame or in a housing. Frames or housings act as holding devices for the plate stack. Sufficient sealing against lateral flows passing the plate stack is also intended to be provided. The cooling device 80 is perpendicularly cut in the centre (sectional plane 82). The outlet opening (outlet window 83) for the breaking gas is shown at the front of the drawing and the rear region of the cooling device is directed towards the arc quenching chamber of the installation device.

The plates 15 are transverse to the flow direction 88 and form the plate stack. In the embodiment shown in FIG. 9, there are twenty-three plates that form the heat capacity of the cooling device together with the frame 84 depending on mass, volume and material. Twenty-two vents 17 are arranged between the plates. These have a vent width 18 that is for example determined by the thickness of spacer elements. The vent width 19 corresponds to the width of the window in the cooling device. The vent width 18 can be graded according to the expected gas mass flow in each case: 100 to 500 μm, or 250 to 400 μm, or even narrower at 200 to 300 μm. The overall cross section of the through-openings is determined substantially by and depending on the breaking capacity and rated current of the installation device. The overall cross section of the through-openings of the embodiment shown in FIG. 9 has an order of magnitude of 300 mm² when the vent width (18) is 0.2 mm, the width (19) is 20 mm and the number of plates is 22.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

2 plate stack

4 stack length (also vent length)

5 stack width

6 shaped metal sheet length

8 shaped metal sheet width

8′ narrow side of the spacer sheet

10 plate of the first shaped metal sheet (regular shape) having bulges

10′ plate without bulges

10″ plate having beading

10″′ plate cut angularly

11 closure sheet having a through-hole

12 connection bulges (for use in punch-bundling)

13 beading

14 through-hole

15 first spacer sheet

15′ additional spacer sheet (centre)

16 plate thickness

17 cavity (vent)

17′ multipart vent

17″ staggered vent

18 vent width (height)

30 metal strip

31 feeding device

33 driving holes (feeding and positioning)

34′ 34″ two metal sheet outlines

35 recess (poss. scrap)

36 stamping the outer shape

64 wide vent in input region

65 narrow vent in outlet region

67 sectional plane

80 cooling device in frame

82 sectional plane

83 window

84 frame

88 flow, breaking gas flow

88′ flow separating into two flow vents

1. A method for producing a cuboid plate stack having a stack length and a stack width, the plate stack including shaped metal sheets that are rectangular or L-shaped and each produced from a metal strip of a uniform thickness by shaping and include first shaped metal sheets having a uniform length that corresponds to the stack length and second shaped metal sheets having a uniform width that is at most equal to the stack width, each first shaped metal sheet including a first portion including a first planar sub-surface and a second portion including a second planar sub-surface, each second shaped metal sheet including a first portion including a first planar sub-surface, the method comprising:
stacking the first and second shaped metal sheets one on top of the other, after the shaping of the shaped metal sheets, such that a plurality of through-cavities, in the form of vents, are formed in longitudinal direction of the stack in parallel with the uniform length between respective planar sub-surfaces of the second portions of the first shaped metal sheets, a respective first portion of the second shaped metal sheets acting as a spacer for forming the vents, and the respective planar sub-surface of the first portion of the second shaped metal sheets resting on the respective planar sub-surface of the first portion of the first shaped metal sheets; and
interconnecting the shaped metal sheets in a captive manner so as to form a self-supporting structure of a plate stack,
wherein, in order to produce the self-supporting structure, each of the planar sub-surfaces of at least the first portion, of the first and second shaped metal sheets is provided with debossed bulges such that, when the planar sub-surfaces of first portions of the first and second shaped metal sheets that rest one on top of the other are stacked, bulges and debossed impressions engage with one another.

2. The method according to of claim 1, wherein the first shaped metal sheets have a uniform length and the second shaped metal sheets have different widths.

3. The method of claim 2, comprising: stacking two of the first shaped metal sheets are stacked one on top of the other, followed by one of the second shaped metal sheets.

4. The method of claim 1, wherein each of the first shaped metal sheets is produced so as to have beading by processing the metal strip.

5. (canceled)

6. The method of claim 1, comprising:
shaping the shaped metal sheets using stamping, wire eroding, laser cutting, water jet cutting, or nibbling.

7. (canceled)

8. The method of claim 1, comprising, in order to produce the self-supporting structure:
providing further shaped metal sheets with drill holes; and
interconnecting the shaped metal sheets via the drill holes using rivets following the stacking.

9. The method of claim 1, comprising, in order to produce the self-supporting structure;
introducing further shaped metal sheets into a frame,
wherein the frame can be inserted into an outlet window of an installation device.

10. The method of claim 1, wherein a number of the vents in the longitudinal direction extending in parallel with the stack length is variable.

11. The method claim 1, wherein the metal strip has a thickness in a range of from 0.1 to 0.5 mm.

12. A method of cooling a electrical installation the method comprising:
including a plate stack made by the method of claim 1 in the electrical installation device so as to form a cooling plate arrangement in the electrical installation device.
